(19) United States
(12) Patent Application Publication
(10) Pub. No.: US 2016/0055820 A1
(43) Pub. Date: Feb. 25, 2016

(54) DISPLAY DEVICE

(71) Applicant: Au Optronics Corporation, Hsinchu (TW)

(72) Inventors: Hui Chu Ke, Hsinchu City (TW); Sheng-Wen Cheng, Hsinchu City (TW)

(21) Appl. No.: 14/566,717

(22) Filed: Dec. 11, 2014

(30) Foreign Application Priority Data
Aug. 25, 2014 (TW) 103129179

(51) Int. Cl. G09G 5/02; G09G 5/10

(52) U.S. Cl. CPC G09G 5/02; G09G 5/10

(57) ABSTRACT

A display device is provided. The display device includes a display panel, an image signal input unit, and a sub-pixel rendering (SPR) unit. The display panel includes a plurality of repeating units. Each repeating unit includes at least eight sub-pixels. These sub-pixels include two first color sub-pixels, two second color sub-pixels, two third color sub-pixels, at least one first white sub-pixel, and at least one second white sub-pixel. The first and the second white sub-pixels have different chromaticity and the first and the second white sub-pixels are located in different rows. The image signal input unit serves to receive image signals. The sub-pixel rendering unit is used for performing sub-pixel rendering processes to the image signals, so that the above sub-pixels of the display panel produce performance values.

### CROSS-REFERENCE TO RELATED APPLICATION

This application claims the priority benefit of Taiwan application serial no. 103129179, filed on Aug. 25, 2014. The entirety of the above-mentioned patent application is hereby incorporated by reference herein and made a part of this specification.

### BACKGROUND OF THE INVENTION

1. Field of the Invention

The invention relates to a display device, and more particularly, to a display device capable of reducing white light color washout and having good pixel aperture ratio and image visual resolution.

2. Description of Related Art

As science and technology advance, increasingly higher demands are placed on display devices, wherein the display devices are desired to be light, slim, high-definition and low power-consuming. Especially, with respect to a portable display device, low power consumption and high brightness are the focus of concern. Therefore, in recent years, an RGBW (red, green, blue and white) display panel with increased backlight transmittance and reduced backlight power consumption has been developed. The RGBW display panel includes sub-pixels of four colors including red, green, blue and white, and the brightness of the display panel is enhanced by high transmittance of the white sub-pixels. However, in a conventional RGBW display panel, the white color generated by RGB color mixing differs from the white color of the W sub-pixels in chromaticity. Accordingly, a more complex color adjustment computation is subsequently required in order to achieve RGBW white balance and further to solve a problem of white light color washout.

In addition, there is a technique for improving a pixel aperture ratio by decreasing the number of pixels, so that the brightness of the display panel is enhanced and power saving is then achieved. However, due to the decrease in the number of the pixels of the display panel, the display panel has limited physical resolution (referred to as pixel resolution), and accordingly, a sub-pixel rendering (SPR) method has been further devised. Such rendering method must be implemented using sub-pixels in different arrangements and designs to formulate appropriate algorithms, so as to improve the resolution in displaying an image to sub-pixel resolution. Since sub-pixels are smaller than pixels, to a human eye, it appears that the resolution of the image is increased, which is a condition known as increased visual resolution.

### SUMMARY OF THE INVENTION

The invention provides a display device capable of reducing white light color washout and having good pixel aperture ratio and image visual resolution.

The invention proposes a display device. The display device includes a display panel, an image signal input unit and a sub-pixel rendering (SPR) unit. The display panel includes a plurality of repeating units. Each repeating unit includes at least eight sub-pixels. The sub-pixels include two first color sub-pixels, two second color sub-pixels, two third color sub-pixels, at least one first white sub-pixel and at least one second white sub-pixel. The first and the second white sub-pixels have different chromaticity, and the first and the second white sub-pixels are located in different rows. The image signal input unit is configured to receive an image signal. The sub-pixel rendering unit is configured to perform a sub-pixel rendering process to the image signal, so that the above sub-pixels of the display panel produce a performance value.

The invention proposes another display device. The display device includes a display panel, an image signal input unit and a sub-pixel rendering (SPR) unit. The display panel includes a plurality of repeating units, and each repeating unit includes twelve sub-pixels arranged in an array of two rows and six columns (2×6). The sub-pixels include four first color sub-pixels, four second color sub-pixels, two third color sub-pixels, one first white sub-pixel and one second white sub-pixel. The first and the second white sub-pixels have different chromaticity. The image signal input unit is configured to receive an image signal. The sub-pixel rendering unit is configured to perform a sub-pixel rendering process to the image signal, so that the above sub-pixels of the display panel produce a performance value.

Based on the above, the display panel of the display device of the invention includes the repeating unit that includes the white sub-pixels having different chromaticity, thereby improving white balance of the RGBW display panel, and further solving the problem of white light color washout. In addition, the display device of the invention works in combination with sub-pixels in different arrangements and designs to formulate appropriate algorithms (i.e., sub-pixel rendering methods), so as to improve the resolution in displaying an image to sub-pixel resolution. In this way, the display device of the invention is good in both pixel aperture ratio and image visual resolution.

To make the above features and advantages of the invention more comprehensible, embodiments accompanied with drawings are described in detail as follows.

### BRIEF DESCRIPTION OF THE DRAWINGS

FIG. 1 is a schematic block view of a display device according to an embodiment of the invention.

FIG. 2 is a schematic top view of a repeating unit according to the first embodiment of the invention.

FIG. 3 is a schematic cross-sectional view of a pixel array including the repeating unit in FIG. 2.

FIG. 4 is a schematic cross-sectional view of another pixel array including the repeating unit in FIG. 2.

FIG. 5 to FIG. 11 are schematic top views of some other repeating units according to the first embodiment of the invention.

FIG. 12 is a schematic top view of a repeating unit according to the second embodiment of the invention.

FIG. 13 to FIG. 15 are schematic top views of some other repeating units according to the second embodiment of the invention.

FIG. 16 is a schematic top view of a repeating unit according to the third embodiment of the invention.

FIG. 17 and FIG. 18 are schematic top views of some other repeating units according to the third embodiment of the invention.

### DESCRIPTION OF DISCLOSED EMBODIMENTS

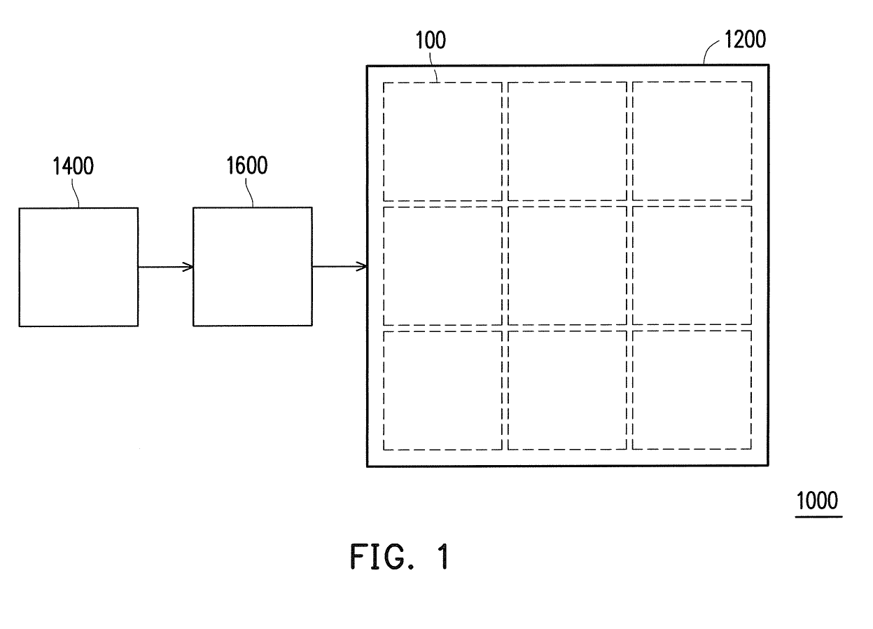

FIG. 1 is a schematic block view of a display device according to an embodiment of the invention. Referring to FIG. 1, a display device 1000 of an embodiment of the invention includes a display panel 1200, an image signal input unit 1400 and a sub-pixel rendering unit 1600.

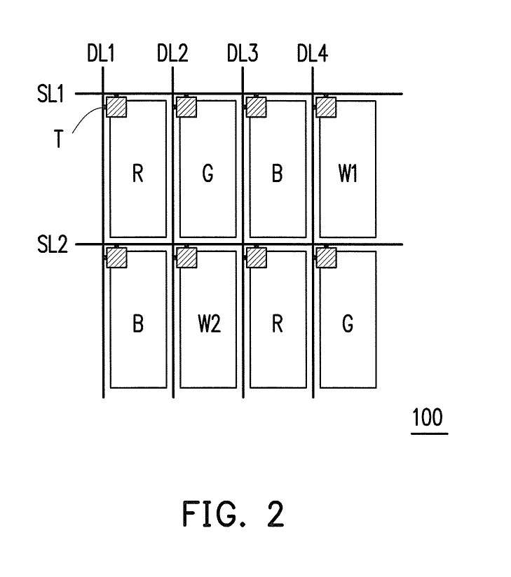

The display panel 1200 of the present embodiment includes a plurality of repeating units 100. FIG. 2 is a schematic top view of the repeating unit 100 according to the first embodiment of the invention. Referring to FIG. 1 and FIG. 2 together, in order to facilitate explanation, FIG. 2 only illustrates one repeating unit 100. However, it is understood by persons of ordinary skill in the art that the display panel 1200 actually includes an array consisting of a plurality of the repeating units 100 (as shown in FIG. 1). Referring to FIG. 1 and FIG. 2 together, the repeating unit 100 of the present embodiment includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. However, the invention is not limited thereto. Particularly, the first white sub-pixel W1 and the second white sub-pixel W2 have different chromaticity. As shown in FIG. 2, the first color sub-pixel R, the second color sub-pixel G, the third color sub-pixel B, the first white sub-pixel W1 and the second white sub-pixel W2 each have one of scan lines SL1 and SL2, one of data lines DL1 to DL4, and one driving element T. If the display panel 1200 is a thin film transistor liquid crystal display (TFT-LCD), the driving element T is, e.g., a thin film transistor (TFT). However, the invention is not limited thereto. If the display panel 1200 is an organic electroluminescent display panel (e.g., organic light-emitting diode (OLED)), the driving element T includes, e.g., two TFTs and one capacitor. However, the invention is not limited thereto. The driving element T is electrically connected to a scan line and a data line. As shown in FIG. 2, one repeating unit 100 includes two scan lines SL1 and SL2 and four data lines DL1 to DL4.

Specifically, the first row of the repeating unit 100 includes, from left to right, the first color sub-pixel R, the second color sub-pixel G, the third color sub-pixel B and the first white sub-pixel W1. The second row of the repeating unit 100 includes, from left to right, the third color sub-pixel B, the second white sub-pixel W2, the first color sub-pixel R and the second color sub-pixel G (arrangement 1). However, the present embodiment does not impose any limitations on the arrangement manner of the sub-pixels of the repeating unit. Particularly, in the present embodiment, the first white sub-pixel W1 and the second white sub-pixel W2 are located in different rows. However, the invention is not limited thereto. The sub-pixels in the first row are driven by the scan line SL1, and the sub-pixels in the second row are driven by the scan line SL2. For example, the first color sub-pixel R located in the first row and the first column is driven by the scan line SL1 and the data line DL1, while the first color sub-pixel R located in the second row and the third column is driven by the scan line SL2 and the data line DL3. In the present embodiment, the first color sub-pixel R is a red sub-pixel, the second color sub-pixel G is a green sub-pixel, and the third color sub-pixel B is a blue sub-pixel. However, the invention is not limited thereto. In other embodiments, the first color sub-pixel R, the second color sub-pixel G and the third color sub-pixel B may be any arbitrary combination of other colors.

Particularly, in the repeating unit 100, any two sub-pixels of the same color located in different rows are alternately arranged. More specifically, the first color sub-pixel R located in the first row and the first color sub-pixel R located in the second row are located in different columns, the second color sub-pixel G located in the first row and the second color sub-pixel G located in the second row are located in different columns, the third color sub-pixel B located in the first row and the third color sub-pixel B located in the second row are located in different columns, and the first white sub-pixel W1 and the second white sub-pixel W2 are located in different columns.

Referring again to FIG. 1, the image signal input unit 1400 in the display device 1000 is configured to receive an image signal. The sub-pixel rendering unit 1600 in the display device 1000 is configured to perform a sub-pixel rendering process to the image signal received by the image signal input unit 1400, so that the sub-pixels of the display panel 1200 produce a performance value. In the present embodiment, the above performance value is brightness. However, the invention is not limited thereto. In other embodiments, the performance value may be hue, lightness, saturation or gray level. For example, the brightness is 0 nit or greater, the hue is 0 to 360 degrees, the lightness is 0 to 100, the saturation is 0 or greater, and the gray level is 0 to 255. In the following, the repeating unit 100 in FIG. 2 serves as an example for illustrating a rendering method of the display device 1000 of an embodiment of the invention.

First, the image signal input unit 1400 receives image signals corresponding to a first color space, namely, image signals of the first color sub-pixel R, the second color sub-pixel G, the third color sub-pixel B, the first white sub-pixel W1 and the second white sub-pixel W2 at a specific color level of the repeating unit 100 in FIG. 2. Next, the sub-pixel rendering unit 1600 performs sub-pixel rendering processes to the image signals received by the image signal input unit 1400, wherein the image signals of the first color sub-pixel R, the second color sub-pixel G, the third color sub-pixel B, the first white sub-pixel W1 and the second white sub-pixel W2 are respectively transformed from the image signals of the first color space into image signals of a second color space through a transformation matrix. Then, all of the first color sub-pixels R, the second color sub-pixels G, the third color sub-pixels B, the first white sub-pixels W1 and the second white sub-pixels W2 of the display panel 1200 respectively display corresponding red, green, blue and white performance values. In the present embodiment, dimensions of the employed transformation matrix are 3×3. However, the invention is not limited thereto.

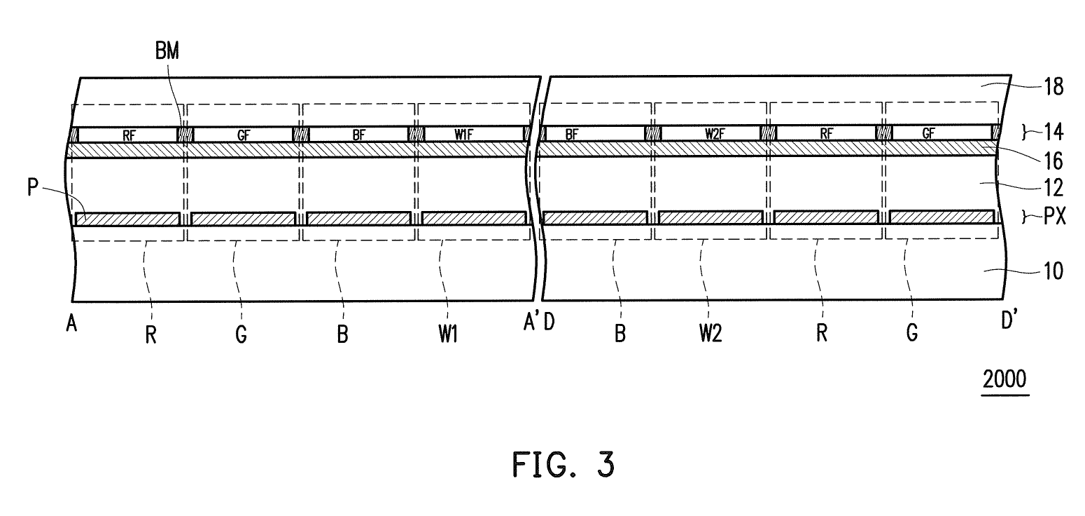

The repeating units according to the embodiments of the invention are applicable to any suitable display panel, e.g., an LCD, an OLED or an electrophoresis display panel, etc. However, the invention is not limited thereto. FIG. 3 is a schematic cross-sectional view of a pixel array including the repeating unit 100 in FIG. 2. Referring to FIG. 2 and FIG. 3 together, the present embodiment takes an LCD as an example. A pixel array 2000 of the LCD includes a substrate 10, an opposite substrate 18, a device layer PX, liquid crystal molecules 12 and a color filter 14.

A material of the substrate 10 includes glass, quartz, organic polymers, or opaque/reflective materials (e.g., metals), etc. The opposite substrate 18 is located opposite the substrate 10. A material of the opposite substrate 18 includes glass, quartz or organic polymers, etc. The liquid crystal molecules 12 are located between the substrate 10 and the opposite substrate 18.

The color filter 14 is located on the opposite substrate 18. However, the invention is not limited thereto. In other embodiments, the color filter 14 may be located on the substrate 10. Line AA′ in FIG. 3 crosses the first row of the repeating unit 100 in FIG. 2 from left to right. Referring to FIG. 3, the color filter 14 of the present embodiment includes, from left to right along line AA′, a first color filter pattern RF, a second color filter pattern GF, a third color filter pattern BF and a first white filter pattern W1F. Line DD′ in FIG. 3 crosses the second row of the repeating unit 100 in FIG. 2 from left to right. The color filter 14 of the present embodiment includes, from left to right along line DD′, the third color filter pattern BF, a second white filter pattern W2F, the first color filter pattern RF and the second color filter pattern GF. The first white filter pattern W1F includes, e.g., a transparent photoresist material, and the second white filter pattern W2F includes, e.g., an insulating material. However, the invention is not limited thereto. In some embodiments, one of the first white filter pattern W1F and the second white filter pattern W2F includes a small number of the first color filter patterns RF, the second color filter patterns GF or the third color filter patterns BF. For example, when the display device 1000 displays a yellowish white point, such problem of white light color washout may be fixed by having one of the first white filter pattern W1F and the second white filter pattern W2F include a small number of blue filter patterns. In other embodiments, the color filter 14 may have color filter patterns in other arrangements. In addition, the opposite substrate 18 further includes a black matrix BM disposed thereon. The black matrix BM includes a plurality of openings (not denoted), and the first color filter pattern RF, the second color filter pattern GF, the third color filter pattern BF, the first white filter pattern W1F and the second white filter pattern W2F are disposed respectively in these openings.

In the present embodiment, the opposite substrate 18 further includes an electrode layer 16 disposed thereon. The electrode layer 16 is a transparent conductive layer, and a material thereof includes a metal oxide, e.g., an indium tin oxide or an indium zinc oxide, etc. The electrode layer 16 is located between the color filter 14 and the liquid crystal molecules 12. In the present embodiment, the electrode layer 16 completely covers the color filter 14. However, the invention is not limited thereto. The electrode layer 16 generates an electric field between itself and the device layer PX to control or drive the liquid crystal molecules 12.

The substrate 10 includes the device layer PX disposed thereon. In the present embodiment, the device layer PX includes a plurality of pixel structures P. The pixel structure P includes components (not illustrated) such as a scan line, a data line, a driving element, a pixel electrode and a protective layer. Each color sub-pixel of the pixel array 2000 includes the pixel structure P, the liquid crystal molecules 12 and a color filter pattern. For example, referring to FIG. 2 and FIG. 3 together, the first color sub-pixel R in the first row of the repeating unit 100 includes the pixel structure P, the liquid crystal molecules 12, and the first color filter pattern RF disposed corresponding thereto. For another example, the second white sub-pixel W2 in the second row of the repeating unit 100 includes the pixel structure P, the liquid crystal molecules 12, and the second white filter pattern W2F disposed corresponding thereto. In the present embodiment, the first color sub-pixel R is a red sub-pixel, the second color sub-pixel G is a green sub-pixel, and the third color sub-pixel B is a blue sub-pixel. However, the invention is not limited thereto.

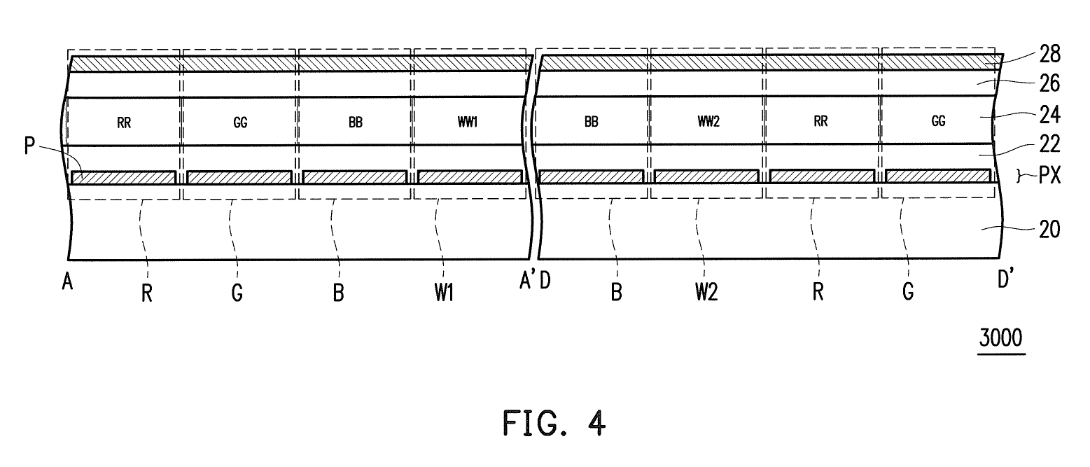

As mentioned above, the repeating units according to the embodiments of the invention may also be applied to an OLED. FIG. 4 is a schematic cross-sectional view of another pixel array including the repeating unit 100 in FIG. 2. Referring to FIG. 4, a pixel array 3000 of the OLED includes a substrate 20, a first organic material layer 22, an organic light-emitting layer 24, a second organic material layer 26 and an electrode layer 28.

The substrate 20 includes a transparent material or a nontransparent material, and is a rigid substrate (e.g., a glass substrate) or a flexible substrate (e.g., a plastic substrate). The substrate 20 includes the device layer PX disposed thereon. In the OLED of the present embodiment, the device layer PX includes a plurality of the pixel structures P. The pixel structure P includes components (not illustrated) such as a scan line, a data line, a driving element, a pixel electrode and a protective layer.

The first organic material layer 22 above the device layer PX further includes at least one of a hole injection layer (HIL) and a hole transport layer (HTL). The hole injection layer and the hole transport layer are formed by, e.g., evaporation. However, the invention is not limited thereto.

The organic light-emitting layer 24 is disposed on the first organic material layer 22. Line AA′ in FIG. 4 crosses the first row of the repeating unit 100 in FIG. 2 from left to right. Referring to FIG. 4, the organic light-emitting layer 24 of the present embodiment includes, from left to right along line AA′, a first color light-emitting material RR, a second color light-emitting material GG, a third color light-emitting material BB and a first white light-emitting material WW1. Line DD′ in FIG. 4 crosses the second row of the repeating unit 100 in FIG. 2 from left to right. Referring to FIG. 4, the organic light-emitting layer 24 of the present embodiment includes, from left to right along line DD′, the third color light-emitting material BB, a second white light-emitting material WW2, the first color light-emitting material RR and the second color light-emitting material GG. In the present embodiment, the first color light-emitting material RR is a red light-emitting material, the second color light-emitting material GG is a green light-emitting material, and the third color light-emitting material BB is a blue light-emitting material. However, the invention is not limited thereto.

Each color sub-pixel of the pixel array 3000 includes the pixel structure P, and a color light-emitting material disposed corresponding thereto. For example, referring to FIG. 2 and FIG. 4 together, the first color sub-pixel R includes the pixel structure P, and the first color light-emitting material RR disposed corresponding thereto. For another example, the third color sub-pixel B in the second row of the repeating unit 100 includes the pixel structure P, and the third color light-emitting material BB disposed corresponding thereto. In the present embodiment, the first color sub-pixel R is a red sub-pixel, the second color sub-pixel G is a green sub-pixel, and the third color sub-pixel B is a blue sub-pixel. However, the invention is not limited thereto.

The second organic material layer 26 is located on the organic light-emitting layer 24. The second organic material layer 26 includes at least one of an electron transport layer (ETL) and an electron injection layer (EIL). The electron transport layer and the electron injection layer are formed by, e.g., evaporation. However, the invention is not limited thereto.

The electrode layer 28 is located on the second organic material layer 26. A material of the electrode layer 28 includes a transparent metal oxide conductive material, e.g., an indium tin oxide, an indium zinc oxide, an aluminum tin oxide, an aluminum zinc oxide, an indium germanium zinc oxide, or other suitable oxide, or a stacked layer of at least two of the above. However, the invention is not limited thereto. In addition, if necessary, a component such as a polarizer or a cover plate or the like may be formed on the electrode layer 28. However, the invention is not limited thereto.

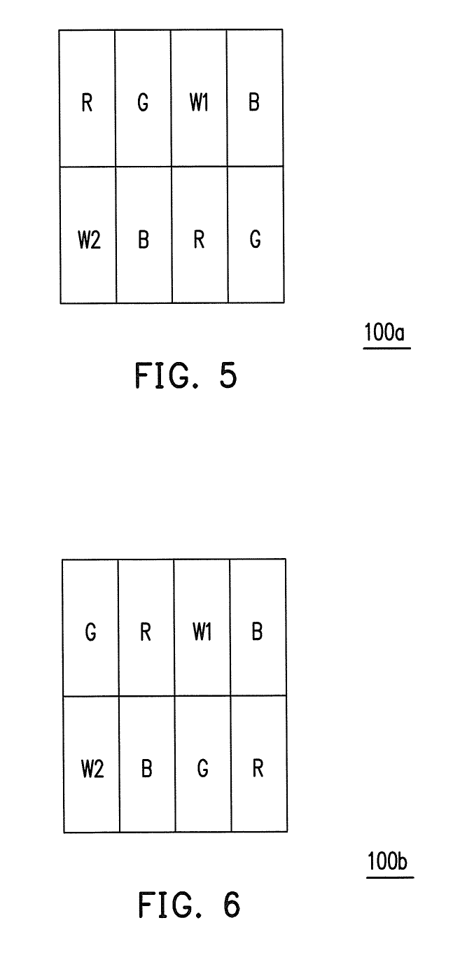

FIG. 5 to FIG. 11 are schematic top views of some other repeating units according to the first embodiment of the invention. In order to facilitate explanation, components such as the scan lines SL1 and SL2, the data lines DL1 to DL4 and the driving element T are not illustrated in FIG. 5 to FIG. 11. Repeating units shown in FIG. 5 to FIG. 11 are similar to the repeating unit 100 in FIG. 2. Thus, the same or similar elements are indicated by the same or similar reference numerals, and descriptions thereof are not repeated herein. The repeating units shown in FIG. 5 to FIG. 11 differ from the repeating unit 100 in FIG. 2 in that, the first color sub-pixel R, the second color sub-pixel G, the third color sub-pixel B, the first white sub-pixel W1 and the second white sub-pixel W2 are arranged in different orders. The arrangement manners of the sub-pixels of each of the repeating units in the present embodiment are respectively described below with reference to the drawings.

Referring first to FIG. 5, a repeating unit 100a includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows. Specifically, the first row of the repeating unit 100a includes, from left to right, the first color sub-pixel R, the second color sub-pixel G, the first white sub-pixel W1 and the third color sub-pixel B. The second row of the repeating unit 100a includes, from left to right, the second white sub-pixel W2, the third color sub-pixel B, the first color sub-pixel R and the second color sub-pixel G (arrangement 2).

Referring to FIG. 6, a repeating unit 100b includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows and different columns. Specifically, the first row of the repeating unit 100b includes, from left to right, the second color sub-pixel G, the first color sub-pixel R, the first white sub-pixel W1 and the third color sub-pixel B. The second row of the repeating unit 100b includes, from left to right, the second white sub-pixel W2, the third color sub-pixel B, the second color sub-pixel G and the first color sub-pixel R (arrangement 3).

Referring to FIG. 7, a repeating unit 100c includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows and different columns. Specifically, the first row of the repeating unit 100c includes, from left to right, the second color sub-pixel G, the first color sub-pixel R, the third color sub-pixel B and the first white sub-pixel W1. The second row of the repeating unit 100c includes, from left to right, the third color sub-pixel B, the second white sub-pixel W2, the second color sub-pixel G and the first color sub-pixel R (arrangement 4).

Particularly, in the repeating units 100a, 100b and 100c shown in FIG. 5 to FIG. 7, any two sub-pixels of the same color located in different rows are alternately arranged. More specifically, the first color sub-pixel R located in the first row and the first color sub-pixel R located in the second row are located in different columns, the second color sub-pixel G located in the first row and the second color sub-pixel G located in the second row are located in different columns, the third color sub-pixel B located in the first row and the third color sub-pixel B located in the second row are located in different columns, and the first white sub-pixel W1 and the second white sub-pixel W2 are located in different columns.

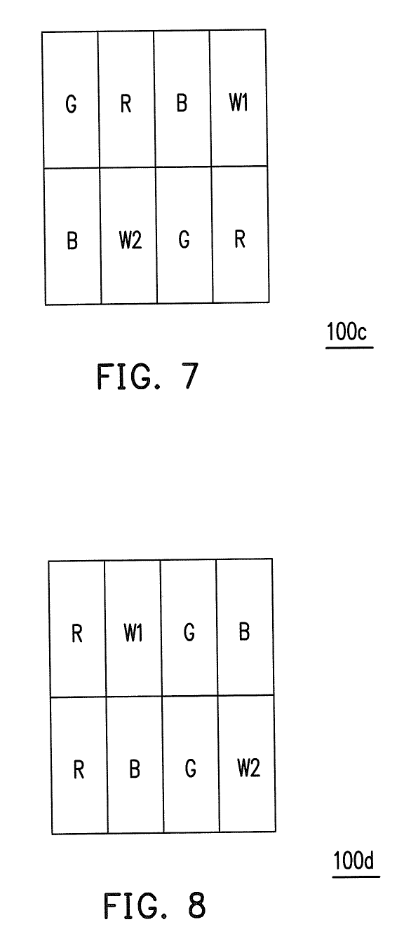

Next, referring to FIG. 8, a repeating unit 100d includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows. Specifically, the first row of the repeating unit 100d includes, from left to right, the first color sub-pixel R, the first white sub-pixel W1, the second color sub-pixel G and the third color sub-pixel B. The second row of the repeating unit 100d includes, from left to right, the first color sub-pixel R, the third color sub-pixel B, the second color sub-pixel G and the second white sub-pixel W2 (arrangement 5). Particularly, in the repeating unit 100d, the third color sub-pixel B located in the first row and the third color sub-pixel B located in the second row are located in different columns, and the first white sub-pixel W1 and the second white sub-pixel W2 are located in different columns.

Referring to FIG. 9, a repeating unit 100e includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows. Specifically, the first row of the repeating unit 100e includes, from left to right, the first color sub-pixel R, the first white sub-pixel W1, the third color sub-pixel B and the second color sub-pixel G. The second row of the repeating unit 100e includes, from left to right, the first color sub-pixel R, the second color sub-pixel G, the third color sub-pixel B and the second white sub-pixel W2 (arrangement 6). Particularly, in the repeating unit 100e, the second color sub-pixel G located in the first row and the second color sub-pixel G located in the second row are located in different columns, and the first white sub-pixel W1 and the second white sub-pixel W2 are located in different columns.

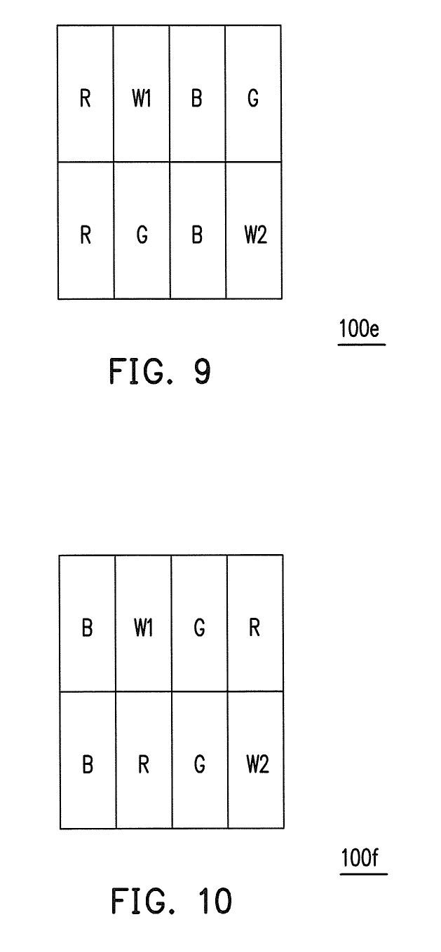

Referring to FIG. 10, a repeating unit 100f includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows. Specifically, the first row of the repeating unit 100f includes, from left to right, the third color sub-pixel B, the first white sub-pixel W1, the second color sub-pixel G and the first color sub-pixel R. The second row of the repeating unit 100f includes, from left to right, the third color sub-pixel B, the first color sub-pixel R, the second color sub-pixel G and the second white sub-pixel W2 (arrangement 7). Particularly, in the repeating unit 100f, the first color sub-pixel R located in the first row and the first color sub-pixel R located in the second row are located in different columns, and the first white sub-pixel W1 and the second white sub-pixel W2 are located in different columns.

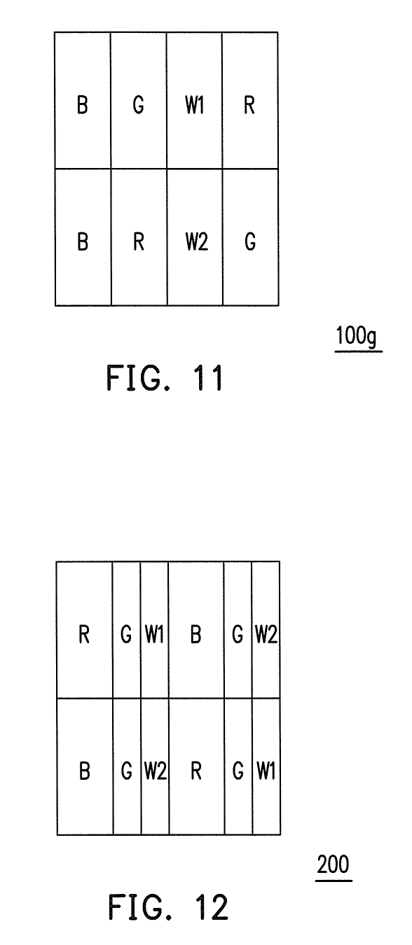

Referring to FIG. 11, a repeating unit 100g includes eight sub-pixels arranged in an array of two rows and four columns (2×4), wherein the eight sub-pixels include two first color sub-pixels R, two second color sub-pixels G, two third color sub-pixels B, one first white sub-pixel W1 and one second white sub-pixel W2. Similarly, the first white sub-pixel W1 and the second white sub-pixel W2 have different chromaticity and are located in different rows. Specifically, the first row of the repeating unit 100g includes, from left to right, the third color sub-pixel B, the second color sub-pixel G, the first white sub-pixel W1 and the first color sub-pixel R. The second row of the repeating unit 100g includes, from left to right, the third color sub-pixel B, the first color sub-pixel R, the second white sub-pixel W2 and the second color sub-pixel G (arrangement 8). Particularly, in the repeating unit 100g, the first color sub-pixel R located in the first row and the first color sub-pixel R located in the second row are located in different columns, and the second color sub-pixel G located in the first row and the second color sub-pixel G located in the second row are located in different columns.

FIG. 12 is a schematic top view of a repeating unit according to the second embodiment of the invention. In order to facilitate explanation, the components such as scan lines, data lines and driving elements are not illustrated in FIG. 12. A repeating unit 200 of the present embodiment includes twelve sub-pixels arranged in an array of two rows and six columns (2×6), wherein the twelve sub-pixels include two first color sub-pixels R, four second color sub-pixels G, two third color sub-pixels B, two first white sub-pixels W1 and two second white sub-pixels W2, wherein the first white sub-pixel W1 and the second white sub-pixel W2 have different chromaticity. In the present embodiment, the first color sub-pixel R is a red sub-pixel, the second color sub-pixel G is a green sub-pixel, and the third color sub-pixel B is a blue sub-pixel. However, the invention is not limited thereto. In other embodiments, the first color sub-pixel R, the second color sub-pixel G and the third color sub-pixel B may be any arbitrary combination of other colors. Particularly, while each of the repeating units 100, 100a, 100b, 100c, 100d, 100e, 100f and 100g of the first embodiment has one first white sub-pixel W1 and one second white sub-pixel W2, each repeating unit 200 of the present embodiment has two first white sub-pixels W1 and two second white sub-pixels W2.

Specifically, the first row of the repeating unit 200 includes, from left to right, the first color sub-pixel R, the second color sub-pixel G, the first white sub-pixel W1, the third color sub-pixel B, the second color sub-pixel G and the second white sub-pixel W2. The second row of the repeating unit 200 includes, from left to right, the third color sub-pixel B, the second color sub-pixel G, the second white sub-pixel W2, the first color sub-pixel R, the second color sub-pixel G and the first white sub-pixel W1 (arrangement 9). However, the present embodiment also does not impose any limitations on the arrangement manner of the sub-pixels of the repeating unit. It is to be noted that, while each of the repeating units 100, 100a, 100b, 100c, 100d, 100e, 100f and 100g of the first embodiment has sub-pixels of four colors in each row, the repeating unit 200 has, in both the first and the second rows, sub-pixels of five colors, namely, the first color sub-pixel R, the second color sub-pixel G, the third color sub-pixel B, the first white sub-pixel W1 and the second white sub-pixel W2.

In addition, in the present embodiment, the first color sub-pixel R and the third color sub-pixel B located in the first row have a larger area than the second color sub-pixel G located in the first row; the first color sub-pixel R and the third color sub-pixel B located in the second row have a larger area than the second color sub-pixel G located in the second row. For example, referring to FIG. 12, the first color sub-pixel R and the third color sub-pixel B located in the first row have an area twice that of the second color sub-pixel G located in the first row; the first color sub-pixel R and the third color sub-pixel B located in the second row have an area twice that of the second color sub-pixel G located in the second row. However, the invention is not limited thereto.

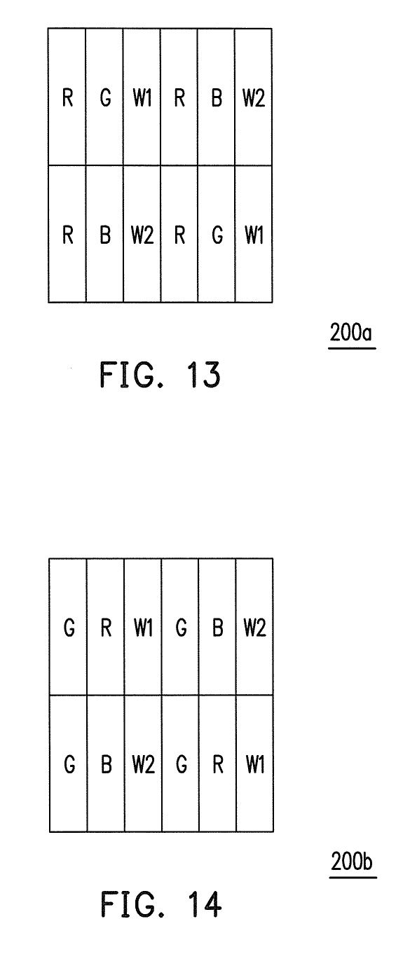

FIG. 13 to FIG. 15 are schematic top views of some other repeating units according to the second embodiment of the invention. In order to facilitate explanation, components such as scan lines, data lines and driving elements are not illustrated in FIG. 13 to FIG. 15. Referring first to FIG. 13, a repeating unit 200a includes twelve sub-pixels arranged in an array of two rows and six columns (2×6), wherein the twelve sub-pixels include four first color sub-pixels R, two second color sub-pixels G, two third color sub-pixels B, two first white sub-pixels W1 and two second white sub-pixels W2, wherein the first white sub-pixel W1 and the second white sub-pixel W2 have different chromaticity. In addition, all of the twelve sub-pixels in the repeating unit 200a have the same area.

Specifically, the first row of the repeating unit 200a includes, from left to right, the first color sub-pixel R, the second color sub-pixel G, the first white sub-pixel W1, the first color sub-pixel R, the third color sub-pixel B and the second white sub-pixel W2. The second row of the repeating unit 200a includes, from left to right, the first color sub-pixel R, the third color sub-pixel B, the second white sub-pixel W2, the first color sub-pixel R, the second color sub-pixel G and the first white sub-pixel W1 (arrangement 10).

In the repeating unit 200a, the second color sub-pixel G located in the first row and the second color sub-pixel G located in the second row are located in different columns, the third color sub-pixel B located in the first row and the third color sub-pixel B located in the second row are located in different columns, the first white sub-pixel W1 located in the first row and the first white sub-pixel W1 located in the second row are located in different columns, and the second white sub-pixel W2 located in the first row and the second white sub-pixel W2 located in the second row are located in different columns.

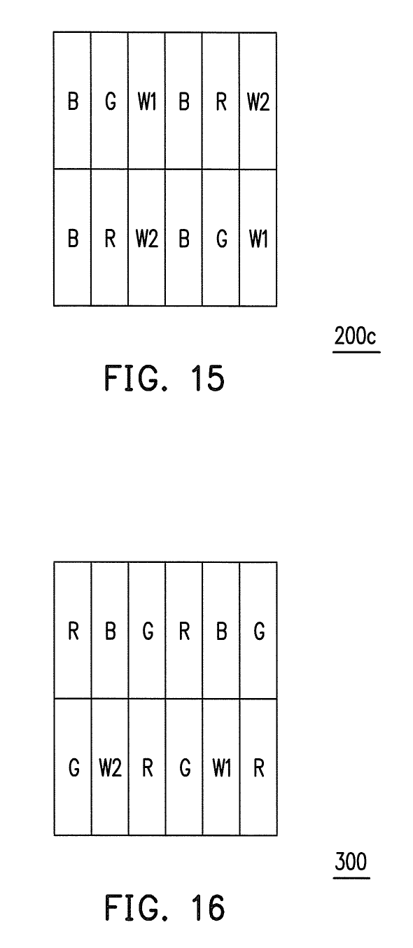

Repeating units shown in FIG. 14 and FIG. 15 are similar to the repeating unit 200a in FIG. 13. Thus, the same or similar elements are indicated by the same or similar reference numerals, and descriptions thereof are not repeated herein. Referring first to FIG. 14, a repeating unit 200b includes twelve sub-pixels arranged in an array of two rows and six columns (2×6), wherein the twelve sub-pixels include two first color sub-pixels R, four second color sub-pixels G, two third color sub-pixels B, two first white sub-pixels W1 and two second white sub-pixels W2, wherein the first white sub-pixel W1 and the second white sub-pixel W2 have different chromaticity. In addition, all of the twelve sub-pixels in the repeating unit 200b have the same area.

Specifically, the first row of the repeating unit 200b includes, from left to right, the second color sub-pixel G, the first color sub-pixel R, the first white sub-pixel W1, the second color sub-pixel G, the third color sub-pixel B and the second white sub-pixel W2. The second row of the repeating unit 200b includes, from left to right, the second color sub-pixel G, the third color sub-pixel B, the second white sub-pixel W2, the second color sub-pixel G, the first color sub-pixel R and the first white sub-pixel W1 (arrangement 11).

In the repeating unit 200b, the first color sub-pixel R located in the first row and the first color sub-pixel R located in the second row are located in different columns, the third color sub-pixel B located in the first row and the third color sub-pixel B located in the second row are located in different columns, the first white sub-pixel W1 located in the first row and the first white sub-pixel W1 located in the second row are located in different columns, and the second white sub-pixel W2 located in the first row and the second white sub-pixel W2 located in the second row are located in different columns.

Next, referring to FIG. 15, a repeating unit 200c includes twelve sub-pixels arranged in an array of two rows and six columns (2×6), wherein the twelve sub-pixels include two first color sub-pixels R, two second color sub-pixels G, four third color sub-pixels B, two first white sub-pixels W1 and two second white sub-pixels W2, wherein the first white sub-pixel W1 and the second white sub-pixel W2 have different chromaticity. In addition, all of the twelve sub-pixels in the repeating unit 200c have the same area.

Specifically, the first row of the repeating unit 200c includes, from left to right, the third color sub-pixel B, the second color sub-pixel G, the first white sub-pixel W1, the third color sub-pixel B, the first color sub-pixel R and the second white sub-pixel W2. The second row of the repeating unit 200c includes, from left to right, the third color sub-pixel B, the first color sub-pixel R, the second white sub-pixel W2, the third color sub-pixel B, the second color sub-pixel G and the first white sub-pixel W1 (arrangement 12).

In the repeating unit 200c, the second color sub-pixel G located in the first row and the second color sub-pixel G located in the second row are located in different columns, the first color sub-pixel R located in the first row and the first color sub-pixel R located in the second row are located in different columns, the first white sub-pixel W1 located in the first row and the first white sub-pixel W1 located in the second row are located in different columns, and the second white sub-pixel W2 located in the first row and the second white sub-pixel W2 located in the second row are located in different columns.

FIG. 16 is a schematic top view of a repeating unit according to the third embodiment of the invention. Referring to FIG. 16, a repeating unit 300 of the present embodiment includes twelve sub-pixels arranged in an array of two rows and six columns (2×6), wherein the twelve sub-pixels include four first color sub-pixels R, four second color sub-pixels G, two third color sub-pixels B, one first white sub-pixel W1 and one second white sub-pixel W2, wherein the first white sub-pixel W1 and the second white sub-pixel W2 have different chromaticity. In the present embodiment, the first color sub-pixel R is a red sub-pixel, the second color sub-pixel G is a green sub-pixel, and the third color sub-pixel B is a blue sub-pixel. However, the invention is not limited thereto. In other embodiments, the first color sub-pixel R, the second color sub-pixel G and the third color sub-pixel B may be any arbitrary combination of other colors.

Particularly, the repeating unit 300 has sub-pixels of three colors in the first row and has sub-pixels of five colors in the second row. Specifically, the first row of the repeating unit 300 includes, from left to right, the first color sub-pixel R, the third color sub-pixel B, the second color sub-pixel G, the first color sub-pixel R, the third color sub-pixel B and the second color sub-pixel G. The second row of the repeating unit 300 includes, from left to right, the second color sub-pixel G, the second white sub-pixel W2, the first color sub-pixel R, the second color sub-pixel G, the first white sub-pixel W1 and the first color sub-pixel R (arrangement 13). That is, in the repeating unit 300, the first white sub-pixel W1 and the second white sub-pixel W2 are located in the same row.

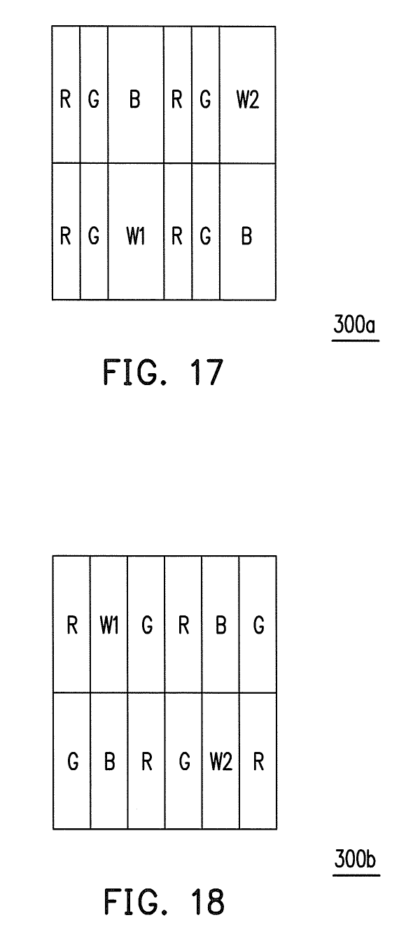

FIG. 17 and FIG. 18 are schematic top views of some other repeating units according to the third embodiment of the invention. Referring first to FIG. 17, a repeating unit 300a includes twelve sub-pixels arranged in an array of two rows and six columns (2×6), wherein the twelve sub-pixels include four first color sub-pixels R, four second color sub-pixels G, two third color sub-pixels B, one first white sub-pixel W1 and one second white sub-pixel W2, wherein the first white sub-pixel W1 and the second white sub-pixel W2 have different chromaticity and are located in different rows.

Specifically, the first row of the repeating unit 300a includes, from left to right, the first color sub-pixel R, the second color sub-pixel G, the third color sub-pixel B, the first color sub-pixel R, the second color sub-pixel G and the second white sub-pixel W2. The second row of the repeating unit 300a includes, from left to right, the first color sub-pixel R, the second color sub-pixel G, the first white sub-pixel W1, the first color sub-pixel R, the second color sub-pixel G and the third color sub-pixel B (arrangement 14).

It is to be noted that, in the repeating unit 300a, any one of the two third color sub-pixels B, the first white sub-pixel W1 and the second white sub-pixel W2 has a larger area than any one of the four first color sub-pixels R and the four second color sub-pixels G. For example, referring to FIG. 17, any one of the two third color sub-pixels B, the first white sub-pixel W1 and the second white sub-pixel W2 has an area twice that of any one of the four first color sub-pixels R and the four second color sub-pixels G. However, the invention is not limited thereto.

Next, referring to FIG. 18, a repeating unit 300b includes twelve sub-pixels arranged in an array of two rows and six columns (2×6), wherein the twelve sub-pixels include four first color sub-pixels R, four second color sub-pixels G, two third color sub-pixels B, one first white sub-pixel W1 and one second white sub-pixel W2, wherein the first white sub-pixel W1 and the second white sub-pixel W2 have different chromaticity and are located in different rows.

Specifically, the first row of the repeating unit 300b includes, from left to right, the first color sub-pixel R, the first white sub-pixel W1, the second color sub-pixel G, the first color sub-pixel R, the third color sub-pixel B and the second color sub-pixel G. The second row of the repeating unit 300b includes, from left to right, the second color sub-pixel G, the third color sub-pixel B, the first color sub-pixel R, the second color sub-pixel G, the second white sub-pixel W2 and the first color sub-pixel R (arrangement 15).

In summary, the display panel of the display device of the invention includes the repeating unit that includes the white sub-pixels having different chromaticity, thereby improving white balance of the RGBW display panel, and further solving the problem of white light color washout. In addition, the display device of the invention works in combination with sub-pixels in different arrangements and designs to formulate appropriate algorithms (i.e., sub-pixel rendering methods), so as to improve the resolution in displaying an image to sub-pixel resolution. In this way, the display device of the invention is good in both pixel aperture ratio and image visual resolution.

Although the invention has been described with reference to the above embodiments, it will be apparent to persons of ordinary skill in the art that modifications to the described embodiments may be made without departing from the spirit of the invention. Accordingly, the scope of the invention will be defined by the attached claims and not by the above detailed descriptions.

What is claimed is:

1. A display device, comprising:
a display panel, comprising a plurality of repeating units, each of the repeating units comprising at least eight sub-pixels, the eight sub-pixels comprising two first color sub-pixels, two second color sub-pixels, two third color sub-pixels, at least one first white sub-pixel and at least one second white sub-pixel, wherein the first and the second white sub-pixels have different chromaticity, and the first and the second white sub-pixels are located in different rows;
an image signal input unit, configured to receive an image signal; and
a sub-pixel rendering unit, configured to perform a sub-pixel rendering process to the image signal, so that the sub-pixels of the display panel produce a performance value.

2. The display device according to claim 1, wherein the first color sub-pixel located in the first row and the first color sub-pixel located in the second row are located in different columns.

3. The display device according to claim 1, wherein the first color sub-pixel located in the first row and the first color sub-pixel located in the second row are located in different columns, and the second color sub-pixel located in the first row and the second color sub-pixel located in the second row are located in different columns.

4. The display device according to claim 1, wherein the first color sub-pixel located in the first row and the first color sub-pixel located in the second row are located in different columns, the second color sub-pixel located in the first row and the second color sub-pixel located in the second row are located in different columns, and the third color sub-pixel located in the first row and the third color sub-pixel located in the second row are located in different columns.

5. The display device according to claim 1, wherein the first color sub-pixel located in the first row and the first color sub-pixel located in the second row are located in different columns, the second color sub-pixel located in the first row and the second color sub-pixel located in the second row are located in different columns, the third color sub-pixel located in the first row and the third color sub-pixel located in the second row are located in different columns, and the first white sub-pixel and the second white sub-pixel are located in different columns.

6. The display device according to claim 1, wherein eight sub-pixels of each of the repeating units that are arranged in an array of two rows and four columns (2×4) have one of the following arrangements:

| | | | |
|---|---|---|---|
| R G B W1 | | R G W1 B | |
| B W2 R G | (arrangement 1) | W2 B R G | (arrangement 2) |
| G R W1 B | | G R B W1 | |
| W2 B G R | (arrangement 3) | B W2 G R | (arrangement 4) |
| R W1 G B | | R W1 B G | |
| R B G W2 | (arrangement 5) | R G B W2 | (arrangement 6) |
| B W1 G R | | B G W1 R | |
| B R G W2 | (arrangement 7) | B R W2 G | (arrangement 8) |

wherein R represents the first color sub-pixel, G represents the second color sub-pixel, B represents the third color sub-pixel, W1 represents the first white sub-pixel and W2 represents the second white sub-pixel.

7. The display device according to claim 1, wherein the performance value is brightness, chromaticity, hue, lightness, saturation or gray level.

8. The display device according to claim 1, wherein each of the repeating units comprises two first white sub-pixels and two second white sub-pixels.

9. The display device according to claim 8, wherein the sub-pixels located in the first row comprise sub-pixels of five colors, and the sub-pixels located in the second row comprise sub-pixels of five colors.

10. The display device according to claim 9, wherein the first color sub-pixel and the third color sub-pixel located in the first row have a larger area than the second color sub-pixel located in the first row, and the first color sub-pixel and the third color sub-pixel located in the second row have a larger area than the second color sub-pixel located in the second row.

11. The display device according to claim 9, wherein twelve sub-pixels of each of the repeating units have one of the following arrangements:
R G W1 B G W2
B G W2 R G W1 (arrangement 9)
R G W1 R B W2
R B W2 R G W1 (arrangement 10)
G R W1 G B W2
G B W2 G R W1 (arrangement 11)
B G W1 B R W2
B R W2 B G W1 (arrangement 12)
wherein R represents the first color sub-pixel, G represents the second color sub-pixel, B represents the third color sub-pixel, W1 represents the first white sub-pixel and W2 represents the second white sub-pixel.

12. A display device comprising:
a display panel, comprising a plurality of repeating units, each of the repeating units comprising twelve sub-pixels arranged in an array of two rows and six columns (2×6), the twelve sub-pixels comprising four first color sub-pixels, four second color sub-pixels, two third color sub-pixels, one first white sub-pixel and one second white sub-pixel, wherein the first and the second white sub-pixels have different chromaticity;
an image signal input unit, configured to receive an image signal; and
a sub-pixel rendering unit, configured to perform a sub-pixel rendering process to the image signal, so that the sub-pixels of the display panel produce a performance value.

13. The display device according to claim 12, wherein the sub-pixels located in the first row comprise sub-pixels of three colors, and the sub-pixels located in the second row comprise sub-pixels of five colors.

14. The display device according to claim 13, wherein the twelve sub-pixels of each of the repeating units have the following arrangement:
R B G R B G
G W2 R G W1 R (arrangement 13)
wherein R represents the first color sub-pixel, G represents the second color sub-pixel, B represents the third color sub-pixel, W1 represents the first white sub-pixel and W2 represents the second white sub-pixel.

15. The display device according to claim 12, wherein the sub-pixels located in the first row comprise sub-pixels of four colors, and the sub-pixels located in the second row comprise sub-pixels of four colors.

16. The display device according to claim 13, wherein the twelve sub-pixels of each of the repeating units have one of the following arrangements:
R G B R G W2
R G W1 R G B (arrangement 14)
R W1 G R B G
G B R G W2 R (arrangement 15)
wherein R represents the first color sub-pixel, G represents the second color sub-pixel, B represents the third color sub-pixel, W1 represents the first white sub-pixel and W2 represents the second white sub-pixel.
